(19) United States
(12) Patent Application Publication
(10) Pub. No.: US 2025/0200159 A1
(43) Pub. Date: Jun. 19, 2025

(54) USER BIOMETRIC AUTHENTICATION SYSTEM AND METHOD, AND APPLICATION USING SAME

(71) Applicant: INDUSTRY-ACADEMIC COOPERATION FOUNDATION, CHOSUN UNIVERSITY, Gwangju (KR)

(72) Inventors: Sung Bum PAN, Gwangju (KR); Young Eun AN, Gwangju (KR)

(21) Appl. No.: 18/916,969

(22) Filed: Oct. 16, 2024

(30) Foreign Application Priority Data
Dec. 15, 2023 (KR) 10-2023-0183732

(51) Int. Cl. G06F 21/32; G06V 40/12; G06V 40/16

(52) U.S. Cl. CPC G06F 21/32; G06V 40/1365; G06V 40/172; G06V 40/174

(57) ABSTRACT

A user biometric authentication system according to an embodiment includes: a user information storage unit that acquires and stores user information and generates facial expression data information; and an authentication unit that, when acquiring authentication request information, acquires authentication facial expression information which is the facial expression data information corresponding to the authentication request information, outputs a preset number of arbitrary face imaging information including the authentication facial expression information as authentication candidate information, and performs user authentication using the authentication candidate information.

### CROSS REFERENCE TO RELATED APPLICATION

The present application claims priority to Korean Patent Application No. 10-2023-0183732, filed Dec. 15, 2023, the entire contents of which are incorporated herein for all purposes by this reference.

### BACKGROUND

The disclosure relates to a user biometric authentication system, method and application using the same, and particularly, the disclosure relates to a user biometric authentication system, method and application using the same, which expands a conventional facial recognition authentication technique to utilize biometric information including various and characteristic facial image patterns and use a 3D selection technique to select an authentication value.

Among biometric authentication techniques, facial recognition is a technique that is convenient for users to use and authenticates users by using a part of the body itself. Since this biometric authentication technique performs user authentication by using a part of the body itself, this has the advantage of making it difficult to steal from the outside, and as a result, this is replacing conventional authentication methods such as passwords, pattern input, and authentication documents stored as files.

Among these security techniques, biometric authentication that uses each individual's physical characteristics has recently been in the spotlight, and in particular, facial recognition authentication has advantages over other authentication methods in terms of authentication speed and method, and thus is widely used on mobile devices.

However, this authentication technique also has the possibility of being stolen by using facial recognition values that are leaked to the outside through image processing without the discerning of a user, and there is also a problem that authentication values may be leaked by using newly developed hacking tools.

### RELATED ART

### Patent Document

Korean Patent Publication No. 10-2019-0136349

### SUMMARY

An embodiment of the disclosure provides a user biometric authentication system, method, and application using the same, which may store multiple user biometric recognition pattern values such as the face, and when mobile authentication is performed, the user may authenticate by selecting a previously registered biometric recognition value such as the face.

In addition, an embodiment of the disclosure provides a user biometric authentication system, method, and application using the same, which may perform strong security authentication because authentication is performed using a facial expression value other than a general facial expression even if a user's face recognition is stolen.

In addition, an embodiment of the disclosure provides a user biometric authentication system, method, and application using the same, which may provide a stronger authentication method by utilizing a user's biometric recognition information, compared to other authentication techniques that are exposed to various existing social engineering attacks.

According to an aspect of the disclosure, a user biometric authentication system is provided. The user biometric authentication system includes: a user information storage unit that acquires and stores user information and generates facial expression data information; and an authentication unit that, when acquiring authentication request information, acquires authentication facial expression information which is the facial expression data information corresponding to the authentication request information, outputs a preset number of arbitrary face imaging information including the authentication facial expression information as authentication candidate information, and performs user authentication using the authentication candidate information.

The user information storage unit may include: a face imaging information acquisition module that acquires face imaging information, which is image information of a user's face included in the user information; and a facial expression data information processing module that analyzes the face imaging information using a preset algorithm and generates and stores the facial expression data information, which is the analysis result.

The face imaging information may include three-dimensional information including depth information and may be acquired with at least two different facial expressions.

The facial expression data information may be generated by digitizing different values for each different facial expression using the depth information of the face imaging information.

the authentication unit may include: an authentication data processing module that acquires the authentication request information and acquires the authentication facial expression information; an authentication candidate information output module that outputs the authentication candidate information including the authentication facial expression information; and an authentication approval module that acquires authentication attempt information, which is selection information for the authentication candidate information, and when the authentication attempt information is analyzed and the user's authentication face imaging information including the same facial expression as the authentication facial expression information is selected, determines that the access is normal to perform the user authentication.

The authentication facial expression information may be included in the authentication request information and may be information previously selected by the user.

The authentication candidate information may include the authentication facial expression information and five pieces of face imaging information other than the authentication facial expression information, and may be selected through a preset algorithm using the facial expression data information corresponding to the face imaging information.

If the authentication attempt information is analyzed and the authentication facial expression information and the authentication face imaging information are not the same, it is determined that the access is abnormal, and the authentication approval module may stop the user authentication and output authentication error information.

The user information storage unit may additionally generate a user's fingerprint data information included in the user information, and the authentication unit may additionally acquire the authentication fingerprint information, which is the fingerprint data information corresponding to the authentication request information, and output the authentication fingerprint information together when outputting the preset number of arbitrary face imaging information as authentication candidate information, and perform user authentication using the authentication candidate information including the authentication fingerprint information and the face imaging information.

According to an aspect of the disclosure, a user biometric authentication method is provided. The user biometric authentication method may include: a user information storage step of acquiring and storing user information using a user information storage unit and generating facial expression data information; and an authentication step of, when acquiring authentication request information, acquiring authentication facial expression information which is the facial expression data information corresponding to the authentication request information using an authentication unit, outputting a preset number of arbitrary face imaging information including the authentication facial expression information as authentication candidate information, and performing user authentication using the authentication candidate information.

The user information storage step may include: a face imaging information acquisition step of acquiring face imaging information, which is image information of a user's face included in the user information; and a facial expression data information processing step of analyzing the face imaging information using a preset algorithm and generating and storing the facial expression data information, which is the analysis result.

The face imaging information may include three-dimensional information including depth information and may be acquired with at least two different facial expressions.

The facial expression data information may be generated by digitizing different values for each different facial expression using the depth information of the face imaging information.

The authentication step may include: an authentication data processing step of acquiring the authentication request information and acquiring the authentication facial expression information; an authentication candidate information output step of outputting the authentication candidate information including the authentication facial expression information; and an authentication approval step of acquiring an authentication attempt information, which is selection information for the authentication candidate information, and if a user's authentication face imaging information including the same facial expression as the authentication facial expression information is selected by analyzing the authentication attempt information, determining that the access is normal to perform the user authentication.

The authentication facial expression information may be included in the authentication request information and may be information previously selected by the user.

The authentication candidate information may include the authentication facial expression information and five pieces of face imaging information other than the authentication facial expression information, and may be selected through a preset algorithm using the facial expression data information corresponding to the face imaging information.

If the authentication attempt information is analyzed and the authentication facial expression information and the authentication face imaging information are not the same, it is determined that the access is abnormal, and the authentication approval step may stop the user authentication and output authentication error information.

The user information storage step may additionally generate a user's fingerprint data information included in the user information, and the authentication step may additionally acquire the authentication fingerprint information, which is the fingerprint data information corresponding to the authentication request information, and output the authentication fingerprint information together when outputting the preset number of arbitrary face imaging information as authentication candidate information, and perform user authentication using the authentication candidate information including the authentication fingerprint information and the face imaging information.

According to an aspect of the disclosure, an application utilizing a user biometric authentication method is provided. The application is stored in a storage medium of a digital terminal to perform: a user information storage step of acquiring and storing user information and generating facial expression data information; and an authentication step of, when acquiring authentication request information, acquiring authentication facial expression information which is the facial expression data information corresponding to the authentication request information, outputting a preset number of arbitrary face imaging information including the authentication facial expression information as authentication candidate information, and performing user authentication using the authentication candidate information.

A user biometric authentication system, method, and application using the same according to an embodiment of the disclosure have the effect of storing multiple biometric recognition pattern values such as faces of a user, and when mobile authentication is performed, the user may authenticate by selecting a biometric recognition value such as a face registered in advance.

In addition, a user biometric authentication system, method, and application using the same according to an embodiment of the disclosure have the effect of performing strong security authentication because authentication is performed using a facial expression value other than a general facial expression even if a user's facial recognition is stolen.

In addition, a user biometric authentication system, method, and application using the same according to an embodiment of the disclosure have the effect of providing a stronger authentication method by utilizing a user's biometric recognition information compared to other authentication techniques that are exposed to various existing social engineering attacks.

In addition, a user biometric authentication system, method, and application using the same according to an embodiment of the disclosure may be effectively applied not only to markets requiring security such as finance and hospitals, but also to various application markets that include entertainment elements such as amusement parks.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a user biometric authentication system according to an embodiment of the disclosure;

FIG. 2 is a block diagram of a user information storage unit of FIG. 1;

FIG. 3 is a block diagram of an authentication unit of FIG. 1;

FIG. 4 is a flow chart of a user biometric authentication method according to an embodiment of the disclosure;

FIG. 5 is a flow chart of step S11 of FIG. 4;

FIG. 6 is a flow chart of step S13 of FIG. 4;

FIG. 7 is an example diagram of authentication candidate information being output according to an embodiment of the disclosure; and

FIG. 8 is an example diagram of selecting authentication attempt information from authentication candidate information and imaging authentication face imaging information according to an embodiment of the disclosure.

### DETAILED DESCRIPTION

Hereinafter, the disclosure will be described with reference to the accompanying drawings. When adding reference numerals to components of each drawing, the same components may have the same numerals as much as possible even if they are shown on different drawings. In addition, when describing the embodiments, if it is determined that a specific description of a related known configuration or function may obscure the gist of the present technical idea, the detailed description may be omitted. When “include,” “have,” “is composed of,” etc. are used in this specification, other parts may be added unless “only” is used. When a component is expressed in a singular number, it may include a case of including a plurality unless there is a special explicit description.

In addition, when describing components of the present disclosure, terms such as first, second, A, B, (a), (b), etc. may be used. These terms are only intended to distinguish the components from other components, and the nature, order, sequence, or number of the components are not limited by the terms.

In the description of the positional relationship of components, if two or more components are described as being “connected”, “combined” or “contacted”, it should be understood that the two or more components may be directly “connected”, “combined” or “contacted”, but the two or more components and another component may be further “interposed” to be “connected”, “combined” or “contacted”. Here, another component may be included in one or more of the two or more components that are “connected”, “combined” or “contacted” with each other.

In the description of a temporal flow relationship related to components, or a method of operation or manufacturing, for example, if the temporal chronological relationship or the flow chronological relationship is described as “after”, “following”, “next to”, “before”, etc., it may also include cases where it is not continuous, unless “right away” or “directly” is used.

Meanwhile, when a numerical value or its corresponding information (e.g., level, etc.) for a component is mentioned, even if there is no separate explicit description, the numerical value or its corresponding information may be interpreted as including an error range that may occur due to various factors (e.g., process factors, internal or external impact, noise, etc.).

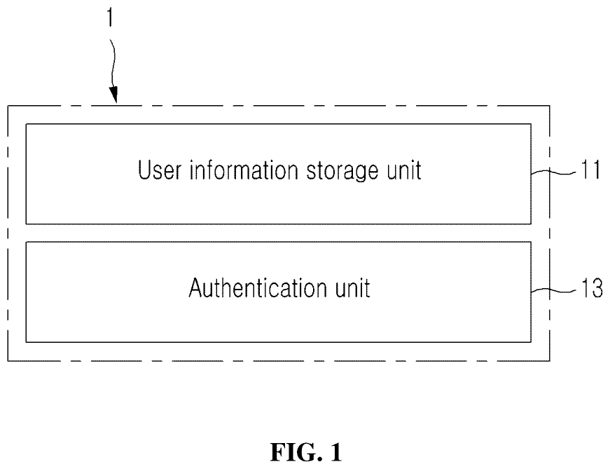

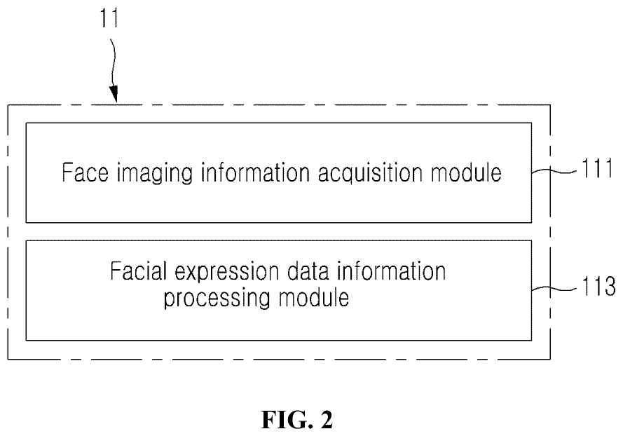

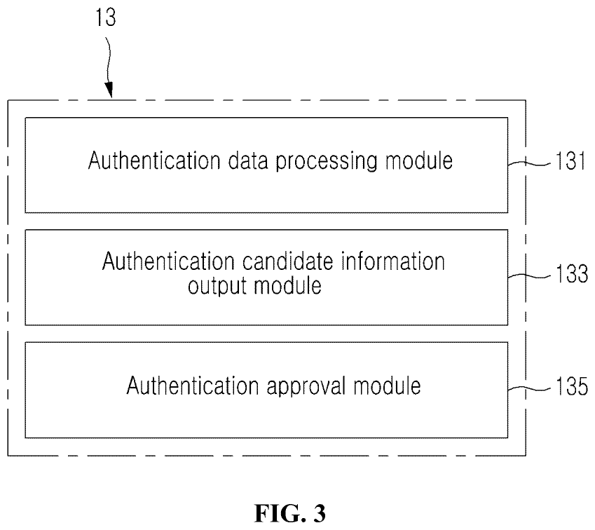

FIG. 1 is a block diagram of a user biometric authentication system according to an embodiment of the disclosure, FIG. 2 is a block diagram of a user information storage unit of FIG. 1, and FIG. 3 is a block diagram of an authentication unit of FIG. 1. Hereinafter, a user biometric authentication system according to an embodiment of the disclosure will be described in detail using FIGS. 1 to 3.

A user biometric authentication system 1 according to an embodiment of the disclosure is configured so that a user selects one of various facial expression images using a 3D polyhedron as an image value stored in advance by the user, and performs user authentication using the facial expression, by extending the existing simple facial image authentication technique. To this end, a user biometric authentication system 1 according to an embodiment of the disclosure is configured to include a user information storage unit 11 and an authentication unit 13 as shown in FIG. 1.

The user information storage unit 11 of the disclosure is configured to acquire and store user information and generate facial expression data information. To this end, the user information storage unit 11 may be configured to include a face imaging information acquisition module 111 and a facial expression data information processing module 113 as shown in FIG. 2.

The face imaging information acquisition module 111 is configured to acquire face imaging information, which is image information of a user's face included in the user information. Here, the face imaging information may be acquired including 3D information including depth information, and may be acquired with at least two different facial expressions.

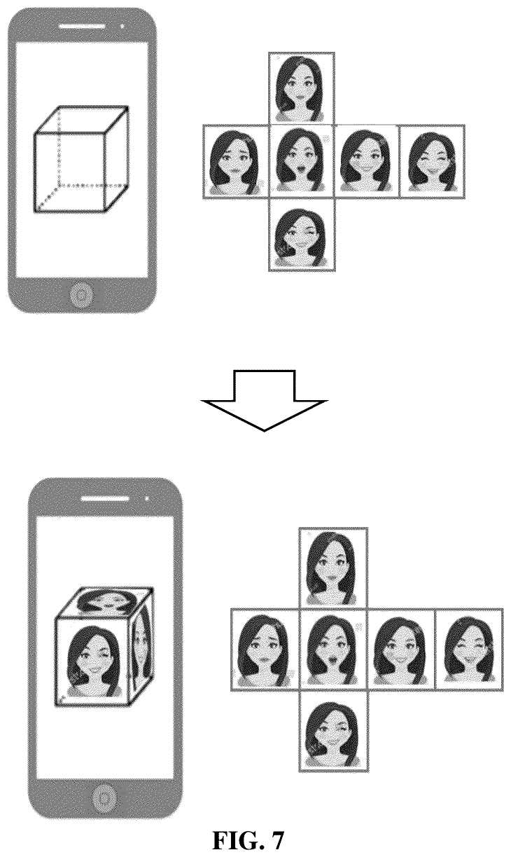

In an embodiment of the disclosure, face imaging information of at least six different facial expressions may be acquired. This may be for a user to decide which facial expression to use for authentication, or for an application using the disclosure to select a facial expression requesting authentication through a preset algorithm or random selection. More specifically, in an embodiment of the disclosure, as shown in FIG. 7, a screen for selecting facial expressions is output in the form of a 3D dice, and at least six different facial expressions may be acquired so that all six faces contain different expressions, in order to allow a user to roll the dice to decide which expression to select as the authentication expression.

In addition, the face imaging information acquisition module 111 may preferably acquire face imaging information using a ToF camera or a lidar camera, because, as described above, the face imaging information must include 3D information including depth information in order to distinguish facial expressions.

The facial expression data information processing module 113 is configured to analyze the face imaging information using a preset algorithm and generate and store facial expression data information as the analysis result. Here, the facial expression data information may be digitized and stored, and for example, may be digitized using 3D information included in the face imaging information. 3D information is one of the main factors that allows a user's facial outline to be accurately identified. Therefore, the facial expression data information processing module 113 according to an embodiment of the disclosure may digitize different values for different facial expressions using depth information included in the face imaging information, and for convenience of explanation, the value of the facial expression data information digitized is defined as a facial expression value.

The authentication unit 13 of the disclosure is configured to, when acquiring authentication request information, acquire authentication facial expression information, which is facial expression data information corresponding to the authentication request information, output a preset number of arbitrary face imaging information including the authentication facial expression information as authentication candidate information, and perform user authentication using the authentication candidate information. To this end, the authentication unit 13 according to an embodiment of the disclosure is configured to include an authentication data processing module 131, an authentication candidate information output module 133, and an authentication approval module 135, as shown in FIG. 3.

The authentication data processing module 131 is configured to acquire authentication request information and acquire authentication facial expression information. Here, the authentication facial expression information is included in the authentication request information and may be information previously selected by a user.

The user biometric authentication system 1 of an embodiment of the disclosure acquires a plurality of face imaging information as described above. In an authentication process, if multiple face imaging information is used as information for authentication, the meaning of multiple face imaging information disappears. Therefore, the authentication data processing module 131 according to an embodiment of the disclosure may be configured to, when acquiring the authentication request information, acquire authentication facial expression information included in the authentication request information. The authentication facial expression information may be face imaging information selected among multiple face imaging information to check whether to match for authentication during the authentication process. This may be directly selected by a user during each authentication process, or one of the face imaging information stored automatically for each authentication process may be selected through a preset algorithm.

The authentication candidate information output module 133 is configured to output authentication candidate information including authentication facial expression information. Here, the authentication candidate information may include authentication facial expression information and five other face imaging information, and may be selected through a preset algorithm using facial expression data information corresponding to the face imaging information. Authentication candidate information may be configured by outputting the dice of FIG. 7 as described above so that a user may select a facial expression of one side of the dice.

Here, the preset algorithm may include, for example, an algorithm that uses preset similarity information. In an embodiment, when the preset similarity information is 3, the authentication candidate information may allow to select three of the facial expression data information having a facial expression data information numerical value that is included within the preset similarity range among the facial expression data information numerical values of the authentication facial expression information, and select the remaining two from the face imaging information having facial expression data information numerical values that are outside the preset similarity range.

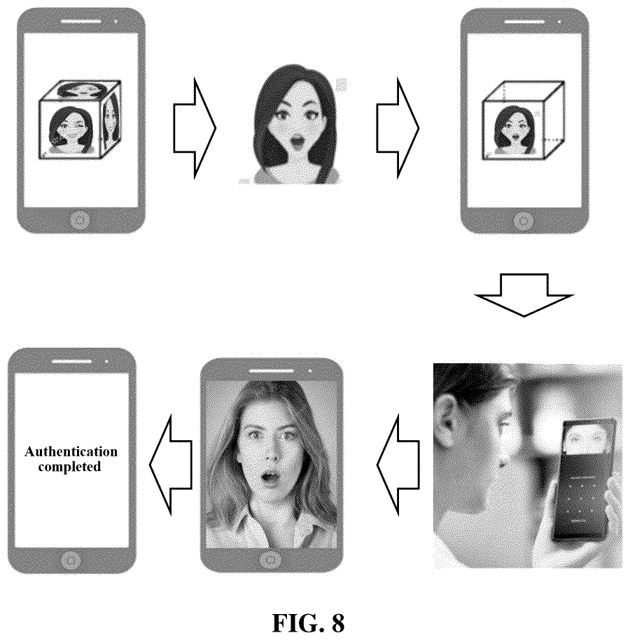

The authentication approval module 135 is configured to acquire authentication attempt information, which is selection information for the authentication candidate information, and if the authentication attempt information is analyzed and it is determines that a user's authentication face imaging information including the same facial expression as the authentication facial expression information is selected, determine that the access is normal to perform user authentication, and may go through a process similar to an example of FIG. 8.

The authentication approval module 135 is configured to perform user authentication by analyzing the authentication attempt information after acquiring the input authentication attempt information when the authentication candidate information is output and auser inputs the authentication attempt information, which is selection information for the authentication candidate information.

As described above, the authentication candidate information is output to a user using a dice with six sides. When a user rolls the authentication candidate information dice and selects one side, the authentication approval module 135 of the disclosure checks whether the selected side is the same face imaging information as the preset authentication facial expression information. At this time, if the same face imaging information as the preset authentication facial expression information is selected, the authentication approval module 135 of the disclosure may output a request to make the same user's face as the corresponding facial expression, and may acquire authentication face imaging information by imaging the user's face. When the authentication face imaging information is acquired, the authentication approval module 135 according to an embodiment of the disclosure verifies the identity of the authentication facial expression information and the authentication face imaging information, and if it is confirmed that the two pieces of information have the same facial expression, it may be determined that the user has passed the authentication by determining that the access is normal.

In addition, the authentication approval module 135 may be configured to analyze the authentication attempt information, and if the authentication facial expression information and the authentication face imaging information are not the same or if a user selects the wrong dice face, determine that the access is abnormal, to stop the user authentication and output authentication error information.

As described above, the user biometric authentication system 1 of the disclosure may achieve sufficiently strong security authentication, since a predetermined arbitrary number of authentication candidate information corresponding to various facial expressions is used even if only facial expression information is used as a user's biometric information.

In addition, the disclosure may achieve even stronger security authentication by using multiple biometric information such as fingerprints, irises, retinas, and voices along with facial expression information.

For example, when adding fingerprint information together with facial expression information as biometric information for user authentication, the user information storage unit 11 may additionally generate user fingerprint data information included in the user information. In addition, the authentication unit 13 may additionally acquire fingerprint information for authentication, which is fingerprint data information corresponding to authentication request information. Then, the authentication unit 13 may, when outputting a preset number of arbitrary face imaging information as authentication candidate information, output authentication fingerprint information together, and as a result, perform user authentication using multiple authentication candidate information including face imaging information and authentication fingerprint information.

Here, the authentication unit 13 may, when outputting face imaging information of different facial expressions to each side of a cube in the shape of a 3D dice, output different authentication fingerprint information together with face imaging information to each side of the cube.

In addition, the authentication fingerprint information may be authentication fingerprint information selected to check whether to match for authentication during an authentication process among multiple different authentication fingerprint information, and may be selected directly by a user during each authentication process, or one of multiple different authentication fingerprint information stored automatically during each authentication process through a preset algorithm may be selected.

Likewise, stronger security authentication may be achieved by using multiple authentication candidate information including a user's fingerprint information and the user's facial expression information.

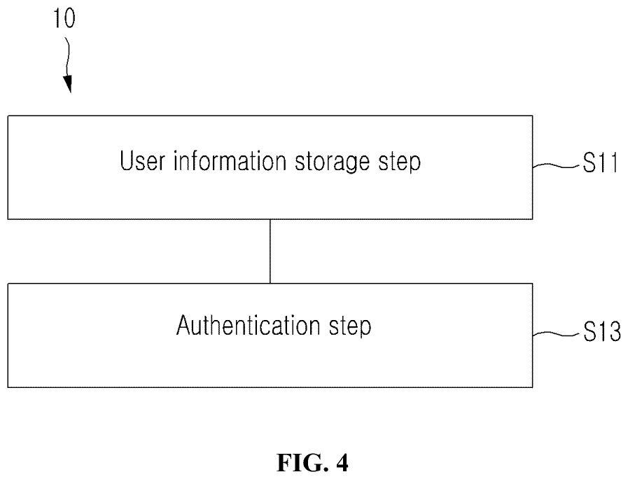

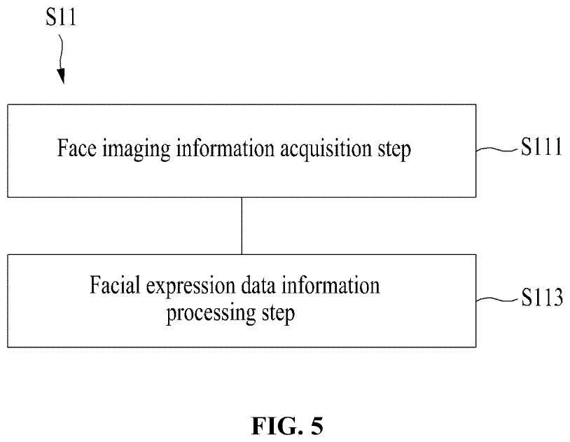

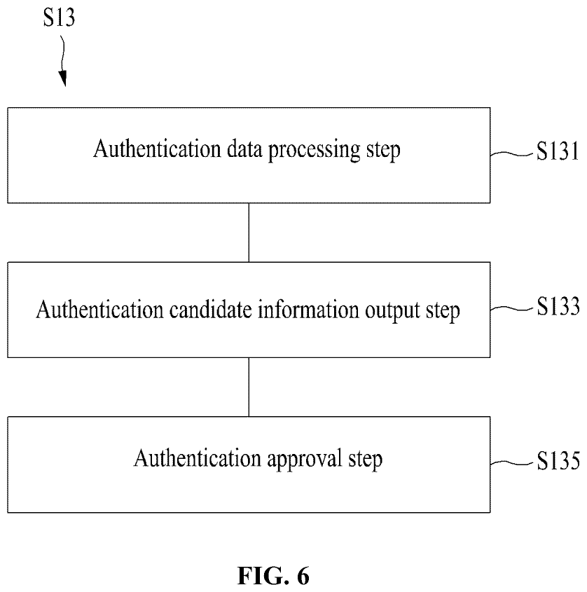

Meanwhile, FIGS. 4 to 6 show a user biometric authentication method according to an embodiment of the disclosure. FIG. 4 is a flow chart of a user biometric authentication method according to an embodiment of the disclosure, FIG. 5 is a flow chart of step S11 of FIG. 4, and FIG. 6 is a flow chart of step S13 of FIG. 4. Hereinafter, a user biometric authentication method according to an embodiment of the disclosure will be described in detail using FIGS. 4 to 6. In addition, for convenience of explanation, a method of the disclosure is described below as using a system of FIG. 1, but this is merely an example for explanation, and the disclosure may be used in various devices, apparatuses, and systems that may perform similar operations or processes.

A user biometric authentication method 10 according to an embodiment of the disclosure is configured so that a user selects one of various facial expression images by utilizing a 3D polyhedron with an image value stored in advance by the user from the existing simple facial image authentication technique, and performs user authentication using the facial expression. To this end, the user biometric authentication method 10 according to an embodiment of the disclosure is configured to include the user information storage step S11 and the authentication step S13 as shown in FIG. 4.

The user information storage step S11 of the disclosure is configured to acquire and store user information using a user information storage unit and generate facial expression data information. To this end, the user information storage step S11 may be configured to include a face imaging information acquisition step S111 and a facial expression data information processing step S113 as shown in FIG. 5.

The face imaging information acquisition step S111 is configured to acquire face imaging information, which is image information of a user's face included in the user information. Here, the face imaging information may be acquired including 3D information including depth information, and may be acquired with at least two different facial expressions.

In an embodiment of the disclosure, face imaging information of at least six different facial expressions may be acquired. This may be for a user to decide which facial expression to use for authentication, or for an application using the disclosure to select a facial expression requesting authentication through a preset algorithm or random selection. More specifically, in an embodiment of the disclosure, as shown in FIG. 7, a screen for selecting facial expressions is output in the form of a 3D dice, and at least six different facial expressions may be acquired so that all six faces contain different expressions, in order to allow a user to roll the dice to decide which expression to select as the authentication expression.

In addition, the face imaging information acquisition step S111 may preferably acquire face imaging information using a ToF camera or a lidar camera, because, as described above, the face imaging information must include 3D information including depth information in order to distinguish facial expressions.

The facial expression data information processing step S113 is configured to analyze face imaging information using a preset algorithm and generate and store facial expression data information as a result of the analysis. Here, the facial expression data information may be digitized and stored, and for example, may be digitized using 3D information included in the face imaging information. 3D information is one of the main factors that allows a user's facial outline to be accurately identified. Therefore, the facial expression data information processing step S113 according to an embodiment of the disclosure may be digitized into different values for different facial expressions using the depth information included in the face imaging information, and for the convenience of explanation, the value of the facial expression data information digitized is defined as a facial expression value hereinafter.

The authentication step S13 of the disclosure is configured to acquire authentication facial expression information, which is the facial expression data information corresponding to the authentication request information, using an authentication unit, output a preset number of arbitrary face imaging information including the authentication facial expression information as authentication candidate information, and perform user authentication using the authentication candidate information. To this end, the authentication step S13 according to an embodiment of the disclosure is configured to include an authentication data processing step S131, an authentication candidate information output step S133, and an authentication approval step S135, as shown in FIG. 6.

The authentication data processing step S131 is configured to acquire authentication request information and acquire authentication facial expression information. Here, the authentication facial expression information is included in the authentication request information and may be information previously selected by a user.

A user biometric authentication method 10 of an embodiment of the disclosure acquires a plurality of face imaging information as described above. In an authentication process, if multiple face imaging information is used as information for authentication, the meaning of multiple face imaging information disappears. Accordingly, the authentication data processing step S131 according to an embodiment of the disclosure may be configured to acquire authentication facial expression information included in the authentication request information when acquiring authentication request information. The authentication facial expression information may be face imaging information selected among multiple face imaging information to check whether to match for authentication during the authentication process. This may be directly selected by a user during each authentication process, or one of the face imaging information stored automatically for each authentication process may be selected through a preset algorithm.

The authentication candidate information output step S133 is configured to output authentication candidate information including authentication facial expression information. Here, the authentication candidate information may include authentication facial expression information and five other face imaging information, and may be selected through a preset algorithm using facial expression data information corresponding to the face imaging information. Authentication candidate information may be configured by outputting the dice of FIG. 7 as described above so that a user may select a facial expression of one side of the dice.

Here, the preset algorithm may include, for example, an algorithm that uses preset similarity information. In an embodiment, when the preset similarity information is 3, the authentication candidate information may allow to select three of the facial expression data information having a facial expression data information numerical value that is included within the preset similarity range among the facial expression data information numerical values of the authentication facial expression information, and select the remaining two from the face imaging information having facial expression data information numerical values that are outside the preset similarity range.

The authentication approval step S135 is configured to acquire authentication attempt information, which is selection information for authentication candidate information, and if the authentication attempt information is analyzed and a user's authentication face imaging information including the same facial expression as the authentication facial expression information is selected, determine that the access is normal to perform user authentication, and may go through a process like an example of FIG. 8.

The authentication approval step S135 is configured to perform user authentication by acquiring the input authentication attempt information and then analyzing the authentication attempt information, if the authentication candidate information is output and a user inputs the authentication attempt information, which is selection information for the authentication candidate information.

As described above, the authentication candidate information is output to a user using a dice with six sides. When a user rolls the authentication candidate information dice and selects one side, the authentication approval step S135 of the disclosure checks whether the selected side is the same face imaging information as the preset authentication facial expression information. At this time, if the same face imaging information as the preset authentication facial expression information is selected, the authentication approval step S135 of the disclosure outputs a request to make the same user's face as the corresponding facial expression, and may acquire authentication face imaging information by imaging the user's face. When the face imaging information for authentication is acquired, the authentication approval step S135 according to an embodiment of the disclosure verifies the identity of the authentication facial expression information and the authentication face imaging information, and if it is confirmed that the two pieces of information have the same facial expression, it may be determined that the user has passed the authentication by determining that the access is normal.

In addition, the authentication approval step S135 may be configured to analyze the authentication attempt information, and if the authentication facial expression information and the authentication face imaging information are not the same or if a user selects the wrong dice face, determine that the access is abnormal, to stop the user authentication and output authentication error information.

As described above, the user biometric authentication method 10 of the disclosure may achieve even stronger security authentication by using multiple biometric information such as fingerprints, irises, retinas, and voices along with facial expression information.

For example, when adding fingerprint information together with facial expression information as biometric information for user authentication, the user information storage step S11 may additionally generate user fingerprint data information included in the user information. In addition, the authentication step S13 may additionally acquire fingerprint information for authentication, which is fingerprint data information corresponding to authentication request information. Then, the authentication step S13 may, when outputting a preset number of arbitrary face imaging information as authentication candidate information, output authentication fingerprint information together, and as a result, perform user authentication using multiple authentication candidate information including face imaging information and authentication fingerprint information.

Likewise, stronger security authentication may be achieved by using multiple authentication candidate information including a user's fingerprint information and the user's facial expression information.

The user biometric authentication method according to embodiments of the disclosure described above may be implemented as an application (computer program) stored in a storage medium of a computer.

Here, the computer may include a user biometric authentication system.

The operating system of the computer may be an operating system such as Windows or Macintosh installed on a general PC such as a desktop or laptop, or a mobile-only operating system such as iOS or Android installed on a mobile terminal such as a smartphone or tablet PC.

The user biometric authentication method according to embodiments of the disclosure described above may be implemented as an application (i.e., computer program) installed by default on a computer or installed by a user, and may be stored (recorded) on a storage medium that is readable by a computer.

An application (computer program) that implements the user biometric authentication method according to embodiments of the disclosure and is stored and executed on a computer storage medium may perform: a user information storage step of acquiring and storing user information and generating facial expression data information; and an authentication step of, when acquiring authentication request information, acquiring authentication facial expression information which is the facial expression data information corresponding to the authentication request information, outputting a preset number of arbitrary biometric imaging information including the authentication facial expression information as authentication candidate information, and performing user authentication using the authentication candidate information.

An application (computer program) that implements the user biometric authentication method using facial expression information according to embodiments of the disclosure and is stored and executed on a computer storage medium may perform: a user information storage step of acquiring and storing user information and generating facial expression data information; and an authentication step of, when acquiring authentication request information, acquiring authentication facial expression information which is the facial expression data information corresponding to the authentication request information, outputting a preset number of arbitrary face imaging information including the authentication facial expression information as authentication candidate information, and performing user authentication using the authentication candidate information.

Likewise, in order for a computer to read a program recorded on a storage medium and execute the user biometric authentication method according to embodiments implemented as a program, the application (application program) described above may include codes coded in a computer language such as C, C++, JAVA, or machine language that is readable by a processor (CPU) of the computer.

Such codes may include functional codes related to functions that define the functions described above, and may also include control codes related to execution procedures necessary for the processor of the computer to execute the functions described above according to a predetermined procedure.

In addition, such codes may further include additional information necessary for the processor of the computer to execute the functions described above, or memory reference codes related to which location (address) of an internal or external memory of the computer should be referenced.

In addition, if the processor of the computer needs to communicate with any other computer or server located remotely in order to execute the aforementioned functions, the codes may further include communication-related codes regarding how the processor of the computer should communicate with any other computer or server located remotely using the computer's communication module (e.g., wired and/or wireless communication module), what information or media should be sent and received during communication, etc.

In addition, a functional program for implementing the present embodiments and codes and code segments related thereto may be easily inferred or modified by programmers in the technical field to which the disclosure belongs, considering the system environment of a computer that reads a storage medium and executes the program.

In addition, the computer-readable storage medium that records a program as described above may be distributed to a computer system connected to a network, so that a computer-readable code may be stored and executed in a distributed manner. In this case, one or more of multiple distributed computers may execute some of the functions presented above and transmit the execution result to one or more of other distributed computers, and a computer that received the result may also execute some of the functions presented above and provide the result to other distributed computers.

As described above, a computer-readable storage medium that records an application for executing the user biometric authentication method using facial expression information according to embodiments of the disclosure may include, for example, a ROM, a RAM, a CD-ROM, a magnetic tape, a floppy disk, an optical media storage device, etc.

In addition, a computer-readable storage medium that records an application, which is a program for executing the user biometric authentication method according to embodiments of the disclosure, may be a storage medium (e.g., a hard disk, etc.) included in an application provider server including a web server related to an application or a corresponding service, or or an application store server, may be an application provider server itself, or may be another computer or its storage medium that records a program.

A computer that may read a storage medium that records an application, which is a program for executing the user biometric authentication method according to embodiments of the disclosure, may include not only general PCs such as general desktops or laptops, but also mobile terminals such as smart phones, tablet Pcs, personal digital assistants (PDAs), and mobile communication terminals, and should be interpreted as all computing-capable devices.

The above description is merely an example of the technical idea of the disclosure, and those with ordinary skill in the art to which the disclosure pertains may make various modifications and variations without departing from the essential characteristics of the disclosure. Therefore, the embodiments disclosed in the disclosure are not intended to limit the technical idea of the disclosure but for explanation, and the scope of the technical idea of the disclosure is not limited by these embodiments. The protection scope of the disclosure should be interpreted by the claims below, and all technical ideas within the equivalent scope should be interpreted as being included in the scope of the rights of the disclosure.

### EXPLANATION OF REFERENCE NUMERALS

1: user biometric authentication system
11: user information storage unit
13: authentication unit
111: face imaging information acquisition module
113: facial expression data information processing module
131: authentication data processing module
133: authentication candidate information output module
135: authentication approval module

What is claimed is:

1. A user biometric authentication system comprising:
a user information storage unit that acquires and stores user information and generates facial expression data information; and
an authentication unit that, when acquiring authentication request information, acquires authentication facial expression information which is the facial expression data information corresponding to the authentication request information, outputs a preset number of arbitrary face imaging information including the authentication facial expression information as authentication candidate information, and performs user authentication using the authentication candidate information.

2. The user biometric authentication system of claim 1, wherein the user information storage unit comprises:
a face imaging information acquisition module that acquires face imaging information, which is image information of a user's face included in the user information; and
a facial expression data information processing module that analyzes the face imaging information using a preset algorithm and generates and stores the facial expression data information, which is an analysis result.

3. The user biometric authentication system of claim 2, wherein the face imaging information comprises three-dimensional information including depth information and is acquired with at least two different facial expressions.

4. The user biometric authentication system of claim 2, wherein the facial expression data information is generated by digitizing different values for each different facial expression using depth information of the face imaging information.

5. The user biometric authentication system of claim 1, wherein the authentication unit comprises:
an authentication data processing module that acquires the authentication request information and acquires the authentication facial expression information;
an authentication candidate information output module that outputs the authentication candidate information including the authentication facial expression information; and
an authentication approval module that acquires authentication attempt information, which is selection information for the authentication candidate information, and when the authentication attempt information is analyzed and the user's authentication face imaging information including a facial expression equal to the authentication facial expression information is selected, determines that an access is normal to perform the user authentication.

6. The user biometric authentication system of claim 5, wherein the authentication facial expression information is included in the authentication request information and is information previously selected by the user.

7. The user biometric authentication system of claim 5, wherein the authentication candidate information comprises the authentication facial expression information and five pieces of face imaging information other than the authentication facial expression information, and is selected through a preset algorithm using the facial expression data information corresponding to the face imaging information.

8. The user biometric authentication system of claim 5, wherein if the authentication attempt information is analyzed and the authentication facial expression information is not equal to the authentication face imaging information, it is determined that the access is abnormal, and the authentication approval module stops the user authentication and outputs authentication error information.

9. The user biometric authentication system of claim 1, wherein the user information storage unit additionally generates a user's fingerprint data information included in the user information, and the authentication unit additionally acquires authentication fingerprint information, which is the fingerprint data information corresponding to the authentication request information, and outputs the authentication fingerprint information together when outputting the preset number of arbitrary face imaging information as authentication candidate information, and performs user authentication using the authentication candidate information including the authentication fingerprint information and the face imaging information.

10. A user biometric authentication method comprising:
a user information storage step of acquiring and storing user information using a user information storage unit and generating facial expression data information; and
an authentication step of, when acquiring authentication request information, acquiring authentication facial expression information which is the facial expression data information corresponding to the authentication request information using an authentication unit, outputting a preset number of arbitrary face imaging information including the authentication facial expression information as authentication candidate information, and performing user authentication using the authentication candidate information.

11. The user biometric authentication method of claim 10, wherein the user information storage step comprises:
a face imaging information acquisition step of acquiring face imaging information, which is image information of a user's face included in the user information; and
a facial expression data information processing step of analyzing the face imaging information using a preset algorithm and generating and storing the facial expression data information, which is an analysis result.

12. The user biometric authentication method of claim 11, wherein the face imaging information comprises three-dimensional information including depth information and is acquired with at least two different facial expressions.

13. The user biometric authentication method of claim 11, wherein the facial expression data information is generated by digitizing different values for each different facial expression using depth information of the face imaging information.

14. The user biometric authentication method of claim 10, wherein the authentication step comprises:
an authentication data processing step of acquiring the authentication request information and acquiring the authentication facial expression information;
an authentication candidate information output step of outputting the authentication candidate information including the authentication facial expression information; and
an authentication approval step of acquiring an authentication attempt information, which is selection information for the authentication candidate information, and if a user's authentication face imaging information including a facial expression equal to the authentication facial expression information is selected by analyzing the authentication attempt information, determining that an access is normal to perform the user authentication.

15. The user biometric authentication method of claim 14, wherein the authentication facial expression information is included in the authentication request information and is information previously selected by the user.

16. The user biometric authentication method of claim 14, wherein the authentication candidate information comprises the authentication facial expression information and five pieces of face imaging information other than the authentication facial expression information, and is selected through a preset algorithm using the facial expression data information corresponding to the face imaging information.

17. The user biometric authentication method of claim 14, wherein if the authentication attempt information is analyzed and the authentication facial expression information is not equal to the authentication face imaging information, it is determined that the access is abnormal, and the authentication approval step stops the user authentication and outputs authentication error information.

18. The user biometric authentication method of claim 10, wherein the user information storage step additionally generates a user's fingerprint data information included in the user information, and the authentication step additionally acquires authentication fingerprint information, which is the fingerprint data information corresponding to the authentication request information, and outputs the authentication fingerprint information together when outputting the preset number of arbitrary face imaging information as authentication candidate information, and performs user authentication using the authentication candidate information including the authentication fingerprint information and the face imaging information.

19. An application stored in a storage medium of a digital terminal to perform:
a user information storage step of acquiring and storing user information and generating facial expression data information; and
an authentication step of, when acquiring authentication request information, acquiring authentication facial expression information which is the facial expression data information corresponding to the authentication request information, outputting a preset number of arbitrary face imaging information including the authentication facial expression information as authentication candidate information, and performing user authentication using the authentication candidate information.
